(19) United States
(12) Patent Application Publication
(10) Pub. No.: US 2008/0039187 A1
(43) Pub. Date: Feb. 14, 2008

(54) Slot machine having re-scrolling function for forming combination of combination symbols, and method of controlling thereof

(75) Inventor: Yoichi Kato, Tokyo (JP)

Correspondence Address: ARENT FOX LLP, 1050 CONNECTICUT AVENUE, N.W., SUITE 400, WASHINGTON, DC, 20036, US

(73) Assignee: Aruze Corp.

(21) Appl. No.: 11/882,951

(22) Filed: Aug. 7, 2007

(30) Foreign Application Priority Data
Aug. 9, 2006 (JP) 2006-217125

(51) Int. Cl. A63F 9/24; A63F 13/00; A63F 13/02

(52) U.S. Cl. 463/20; 463/26; 463/31

(57) ABSTRACT

This invention provides a slot machine having a re-scrolling function for forming a combination of combination symbols, and a method of controlling the slot machine. A CPU 106 is included, which provides functions of: scrolling the symbols displayed on a display 10 in each of mechanical reels 30A through 30E; stopping scrolling after a predetermined period of time; re-scrolling the mechanical reels 30B through 30E other than the mechanical reel 30A on which a first symbol of a predetermined combination is stopped; and stopping re-scrolling of the mechanical reels 30B through 30E such that the first symbol and a second symbol of the combination are arranged adjacent to one another so as to form the combination.

This application is based on and claims the benefit of priority from Japanese Patent Application No. 2006-217125, filed on 9 Aug. 2006, the content of which is incorporated herein by reference.

### BACKGROUND OF THE INVENTION

1. Field of the Invention

The present invention relates to a slot machine that awards a prize according to a arranged symbol combination and a method of controlling thereof, and particularly to a slot machine that provides a re-scrolling function, which offers a combination of combination symbols, and a method of controlling thereof.

2. Related Art

With conventional gaming machines (slot machines), upon the player operating a start lever after the insertion of a predetermined amount of units of a gaming medium (coins or the like), multiple symbol scrolling reels (display device provided in the form of a 3×3 matrix, for example) are rotated, each of which has an outer face on which multiple symbols are displayed.

With the slot machine, after the start lever has been operated, the symbol scrolling reels are rotated a predetermined number of times (during a predetermined period of time), following which the symbol scrolling reels stop rotation. Then, the slot machine pays out a predetermined amount of coins that corresponds to the symbol combination arranged along the active pay line.

In general, each of the aforementioned active pay lines (according to which the number of coins to be paid out is determined) is provided in the shape of a straight line. For example, in an arrangement in which the symbol scrolling reels provide the arranged symbols in the form of a 3×3 matrix, the player is allowed to set a maximum of eight active pay lines (a left side vertical line, a center vertical line, a right side vertical line, an upper side horizontal line, a center horizontal line, a lower side horizontal line, an oblique line from the lower-left side to the upper-right side, and an oblique line from the upper-right side to the lower-left side)

In recent years, various other types of machines have been proposed in addition to slot machines that employ such linear active pay lines. Examples of such various types of machines include: a machine that employs non-linear active pay lines; and a machine having no defined pay line. For example, machines known to employ non-linear active pay lines in addition to linear active pay lines are disclosed in Patent document 1 and Patent document 2.
Patent Document 1: U.S. Pat. No. 6,093,102
Patent Document 2: U.S. Pat. No. 6,960,133

The machines that provide an improved variety of active pay lines, as described above, enhance the player's sense of expectation with respect to the amount of coins to be paid out as compared to conventional machines that employ linear active pay lines.

However, from the perspective of the display format, there is no difference between these machines that affects the player's sense of expectation.

### SUMMARY OF THE INVENTION

A slot machine according to the present invention includes: a display which displays a plurality of symbols; and a game controller which provides functions of: scrolling the symbols displayed on the display in each scrolling line, stopping scrolling after a predetermined period of time, re-scrolling a scrolling line other than a first scrolling line on which a first symbol of the predetermined combination has been stopped, and stopping re-scrolling such that the first symbol and a second symbol of the combination are arranged adjacent to one another so as to form the combination.

With such an arrangement, the scrolling operation is performed for all of the scrolling lines. After a predetermined period of time, the scrolling is temporarily stopped for all the scrolling lines. When there is a combination symbol in the active pay area on one side of the display, the re-scrolling operation is performed for the scrolling lines on which the combination symbols are displayed on the other side thereof, and the re-scrolling operation of the scrolling lines is stopped such that the combination symbol on the one side of the display and the combination symbols on the other side thereof are arranged so as to form a combination. Accordingly, the present invention provides a function whereby, in a case where a predetermined condition has been satisfied, the re-scrolling operation is performed, which changes the symbols thus displayed. Such an arrangement provides the player with an enhanced sense of expectation.

In addition, according to the present invention, the display displays a predetermined active pay area and a predetermined non-active pay area.

With such an arrangement, since the non-active pay area is displayed on the display, the player can predict which of the symbols will transition from the non-active pay area to the active pay area in the re-scrolling operation, which is performed after all the scrolling lines are temporarily stopped after the scrolling is performed for all the scrolling lines for a predetermined period of time. Such an arrangement provides an enhanced sense of expectation to the player.

In addition, according to the present invention, the game controller counts the number of scatter symbols before and after re-scrolling; and the game controller does not award a prize according to the combination of the combination symbols before re-scrolling, and awards a prize according to the combination of the combination symbol on the one side of the display and the combination symbols after re-scrolling and the number of scatter symbols thus counted.

Such an arrangement provides the re-scrolling function which can change the prize to be awarded to the player. This maintains the sense of tension for the player throughout the game, which increases the amusement value of the game.

Moreover, according to the present invention, the game controller counts the number of scatter symbols before and after re-scrolling. The game controller awards a prize according to the combination of the combination symbols before re-scrolling, the combination of the combination symbols after re-scrolling, and the number of scatter symbols thus counted.

With such an arrangement, the prize to be awarded is obtained by calculating the sum of the prize determined before the re-scrolling operation and the prize determined after the re-scrolling operation. Such an arrangement enhances the player's sense of expectation with regard to the re-scrolling operation.

Furthermore, a slot machine according to the present invention includes: a display which displays a plurality of symbols; and a game controller which provides functions of: scrolling the symbols displayed on the display in each scrolling line, stopping scrolling after a predetermined period of time, re-scrolling a scrolling line other than a first scrolling line on which a first symbol of a predetermined combination has been stopped, and stopping re-scrolling such that the first symbol and a second symbol of the combination are arranged adjacent to one another so as to form the combination. With such an arrangement, the display displays a predetermined active pay area and a predetermined non-active pay area.

With such an arrangement, the scrolling is performed for all the scrolling lines. After a predetermined period of time, the scrolling is temporarily stopped for all the scrolling lines. When there is a combination symbol in the active pay area on one side of the display, the re-scrolling operation is performed for the scrolling lines on which the combination symbols are displayed on the other side thereof, and the re-scrolling operation of the scrolling lines is stopped such that the combination symbol on the one side of the display and the combination symbols on the other side thereof are arranged such that they form a combination in the active pay area. Accordingly, the present invention provides a function whereby, in a case where a predetermined condition has been satisfied, the re-scrolling operation is performed, which changes the symbols thus displayed. Such an arrangement provides the player with an enhanced sense of expectation. In addition, according to the present invention, the non-active pay area is displayed on the display. Such an arrangement allows the player to predict which of the symbols will transition from the non-active pay area to the active pay area in the re-scrolling operation, which is performed after all the scrolling lines are temporarily stopped, after the scrolling is performed for all the scrolling lines for a predetermined period of time. Such an arrangement provides an enhanced sense of expectation to the player.

In addition, a slot machine according to the present invention includes: a display which displays a plurality of symbols; and a game controller which provides functions of: scrolling the symbols displayed on the display in each scrolling line, stopping scrolling after a predetermined period of time, re-scrolling a scrolling line other than a first scrolling line on which a first symbol of a predetermined combination has been stopped, and stopping re-scrolling such that the first symbol and a second symbol of the combination are arranged adjacent to one another so as to form the combination. With such an arrangement, the game controller counts the number of scatter symbols before and after re-scrolling operation. The game controller does not award according to the combination of the combination symbols before re-scrolling operation, and awards a prize according to the combination of the combination symbols after re-scrolling operation and the number of scatter symbols thus counted.

With such an arrangement, the scrolling is performed for all the scrolling lines. After a predetermined period of time, the scrolling is temporarily stopped for all the scrolling lines. When there is a combination symbol in the active pay area on one side of the display, the re-scrolling operation is performed for the scrolling lines on which the combination symbols are displayed on the other side thereof, and the re-scrolling operation of the scrolling lines is stopped such that the combination symbol on the one side of the display and the combination symbols on the other side thereof are arranged such that they form a combination in the active pay area. Accordingly, the present invention provides a function whereby, in a case where a predetermined condition has been satisfied, the re-scrolling operation is performed, which changes the symbols thus displayed. Such an arrangement provides the player with an enhanced sense of expectation. Furthermore, the re-scrolling operation according to the present invention can change the prize to be awarded to the player. This maintains the sense of tension for the player throughout the game, thereby improving the amusement value of the game.

In addition, a slot machine according to the present invention includes: a display which displays a plurality of symbols; and a game controller which provides functions of: scrolling the symbols displayed on the display in each scrolling line, stopping of scrolling after a predetermined period of time, re-scrolling a scrolling line other than a first scrolling line on which a first symbol of the predetermined combination is displayed, and stopping re-scrolling such that the first symbol and a second symbol of the combination are arranged adjacent to one another so as to form the combination. With such an arrangement, the game controller counts the number of scatter symbols before and after re-scrolling operation. The game controller awards a prize according to the combination of the combination symbols before re-scrolling, the combination of the combination symbols after re-scrolling, and the number of scatter symbols thus counted.

With such an arrangement, the scrolling is performed for all the scrolling lines. After a predetermined period of time, the scrolling is temporarily stopped for all the scrolling lines. When there is a combination symbol in the active pay area on one side of the display, the re-scrolling operation is performed for the scrolling lines on which the combination symbols are displayed on the other side thereof, and the re-scrolling operation of the scrolling lines is stopped such that the combination symbol on the one side of the display and the combination symbols on the other side thereof are arranged such that they form a combination in the active pay area. Accordingly, the present invention provides a function whereby, in a case where a predetermined condition has been satisfied, the re-scrolling operation is performed, which changes the symbols thus displayed. Such an arrangement provides the player with an enhanced sense of expectation. Furthermore, with the present invention, the prize is obtained by calculating the sum of the prize determined before the re-scrolling operation and the prize determined after the re-scrolling operation. Such an arrangement enhances the player's sense of expectation with regard to the re-scrolling operation.

Furthermore, a slot machine according to the present invention includes: a display which displays a plurality of symbols; and a game controller which provides functions of: scrolling the symbols displayed on the display in each scrolling line, stopping scrolling after a predetermined period of time, re-scrolling a scrolling line other than a first scrolling line on which a first symbol has been stopped; and stopping re-scrolling such that the first symbol and a second symbol of the combination are arranged adjacent to one another so as to form the combination. With such an arrangement, the display displays a predetermined active pay area and a predetermined non-active pay area. Furthermore, the game controller counts the number of scatter symbols before and after re-scrolling. The game controller does not award a prize is according to the combination of the combination symbols before re-scrolling, and awards a prize according to the combination of the combination symbols after re-scrolling and the number of scatter symbols thus counted.

With such an arrangement, the scrolling is performed for all the scrolling lines. After a predetermined period of time, the scrolling is temporarily stopped for all the scrolling lines. When there is a combination symbol in the active pay area on one side of the display, the re-scrolling operation is performed for the scrolling lines on which the combination symbols are displayed on the other side thereof, and the re-scrolling operation of the scrolling lines is stopped such that the combination symbol on the one side of the display and the combination symbols on the other side thereof are arranged such that they form a combination in the active pay area. Accordingly, the present invention provides a function whereby, in a case where a predetermined condition has been satisfied, the re-scrolling operation is performed, which changes the symbols thus displayed. Such an arrangement provides the player with an enhanced sense of expectation. In addition, according to the present invention, the non-active pay area is displayed on the display. Such an arrangement allows the player to predict which of the symbols will transition from the non-active pay area to the active pay area in the re-scrolling operation, which is performed after all the scrolling lines are temporarily stopped, after the scrolling is performed for all the scrolling lines for a predetermined period of time. Such an arrangement provides an enhanced sense of expectation to the player. Furthermore, such an arrangement provides the re-scrolling function which can change the prize to be awarded to the player. This maintains the sense of tension for the player throughout the game, which increases the amusement value of the game.

Moreover, a slot machine according to the present invention includes: a display which displays a plurality of symbols; and a game controller which provides functions of: scrolling the symbols displayed on the display in each scrolling line, stopping scrolling after a predetermined period of time, re-scrolling a scrolling line other than a first scrolling line on which a first symbol has been stopped, and stopping re-scrolling such that the first symbol and a second symbol of the combination are arranged adjacent to one another so as to form the combination. Furthermore, the display displays a predetermined active pay area and a predetermined non-active pay area. In addition, the game controller counts the number of scatter symbols before and after re-scrolling. The game controller awards a prize according to the combination of the combination symbols before re-scrolling, the combination of the combination symbols after re-scrolling, and the number of scatter symbols thus counted.

With such an arrangement, the scrolling is performed for all the scrolling lines. After a predetermined period of time, the scrolling is temporarily stopped for all the scrolling lines. When there is a combination symbol in the active pay area on one side of the display, the re-scrolling operation is performed for the scrolling lines on which the combination symbols are displayed on the other side thereof, and the re-scrolling operation of the scrolling lines is stopped such that the combination symbol on the one side of the display and the combination symbols on the other side thereof are arranged such that they form a combination in the active pay area. Accordingly, the present invention provides a function whereby, in a case where a predetermined condition has been satisfied, the re-scrolling operation is performed, which changes the symbols thus displayed. Such an arrangement provides the player with an enhanced sense of expectation. In addition, according to the present invention, the non-active pay area is displayed on the display. Such an arrangement allows the player to predict which of the symbols will transition from the non-active pay area to the active pay area in the re-scrolling operation, which is performed after all the scrolling lines are temporarily stopped, after the scrolling is performed for all the scrolling lines for a predetermined period of time. Such an arrangement provides an enhanced sense of expectation to the player. Furthermore, with the present invention, the prize to be awarded is obtained by calculating the sum of the prize determined before the re-scrolling operation and the prize determined after the re-scrolling operation. Such an arrangement enhances the player's sense of expectation with regard to the re-scrolling operation.

Furthermore, a method of controlling a slot machine according to the present invention includes processes of: displaying a plurality of symbols on a display; scrolling the symbols displayed on the display in each scrolling line, stopping scrolling after a predetermined period of time; re-scrolling a scrolling line other than a first scrolling line on which a first symbol of a predetermined combination has been stopped; and stopping re-scrolling such that the first symbol and a second symbol of the combination are arranged adjacent to one another so as to form the combination.

With such an arrangement, the scrolling is performed for all the scrolling lines. After a predetermined period of time, the scrolling is temporarily stopped for all the scrolling lines. When there is a combination symbol in the active pay area on one side of the display, the re-scrolling operation is performed for the scrolling lines on which the combination symbols are displayed on the other side thereof, and the re-scrolling operation of the scrolling lines is stopped such that the combination symbol on the one side of the display and the combination symbols on the other side thereof are arranged such that they form a combination. Accordingly, the present invention provides a function whereby, in a case where a predetermined condition has been satisfied, the re-scrolling operation is performed, which changes the symbols thus displayed. Such an arrangement provides the player with an enhanced sense of expectation.

In addition, according to the present invention, a predetermined active pay area and a predetermined non-active pay area are displayed on the display.

With such an arrangement, the non-active pay area is displayed on the display. Such an arrangement allows the player to predict which of the symbols will transition from the non-active pay area to the active pay area in the re-scrolling operation, which is performed after all of the scrolling lines are temporarily stopped, after the scrolling is performed for all the scrolling lines for a predetermined period of time. Such an arrangement provides an enhanced sense of expectation to the player.

Furthermore, according to the present invention, the number of scatter symbols is counted before and after re-scrolling. In a case where re-scrolling is performed, a prize is not awarded according to a combination of the combination symbols before re-scrolling, and a prize is awarded according to a combination of the combination symbols after re-scrolling and the number of scatter symbols thus counted.

Such an arrangement provides the re-scrolling function which can change the prize to be awarded to the player. This maintains the sense of tension for the player throughout the game, which increases the amusement value of the game.

Moreover, according to the present invention, the number of scatter symbols is counted before and after re-scrolling. In a case where re-scrolling is performed, a prize is awarded according to the combination of the combination symbols before re-scrolling, the combination of the combination symbols after re-scrolling, and the number of scatter symbols thus counted.

With such an arrangement, the prize to be awarded is obtained by calculating the sum of the prize determined before the re-scrolling operation and the prize determined after the re-scrolling operation. Such an arrangement enhances the player's sense of expectation with regard to the re-scrolling operation.

In addition, a method of controlling for a slot machine according to the present invention includes processes for: displaying a plurality of symbols on a display; scrolling the symbols displayed statically on the display in each scrolling line; stopping scrolling after a predetermined period of time; re-scrolling a scrolling line other than a first scrolling line on which a first symbol of a predetermined combination has been stopped; and stopping re-scrolling such that the first symbol and a second symbol of the combination are arranged adjacent to one another so as to form the combination. With such an arrangement, a predetermined active pay area and a predetermined non-active pay area are displayed on the display.

With such an arrangement, the scrolling is performed for all the scrolling lines. After a predetermined period of time, the scrolling is temporarily stopped for all the scrolling lines. When there is a combination symbol in the active pay area on one side of the display, the re-scrolling operation is performed for the scrolling lines on which the combination symbols are displayed on the other side thereof, and the re-scrolling operation of the scrolling lines is stopped such that the combination symbol on the one side of the display and the combination symbols on the other side thereof are arranged such that they form a combination in the active pay area. Accordingly, the present invention provides a function whereby, in a case where a predetermined condition has been satisfied, the re-scrolling operation is performed, which changes the symbols thus displayed. Such an arrangement provides the player with an enhanced sense of expectation. In addition, according to the present invention, the non-active pay area is displayed on the display. Such an arrangement allows the player to predict which of the symbols will transition from the non-active pay area to the active pay area in the re-scrolling operation, which is performed after all the scrolling lines are temporarily stopped after the scrolling is performed for all the scrolling lines for a predetermined period of time. Such an arrangement provides an enhanced sense of expectation to the player.

In addition, a method of controlling a slot machine according to the present invention includes processes for: displaying a plurality of symbols on a display; scrolling the symbols displayed on the display in each scrolling line, stopping scrolling after a predetermined period of time; re-scrolling a scrolling lines other than a first scrolling line on which a first symbol of a predetermined combination has been stopped; stopping re-scrolling such that the first symbol and a second symbol of the combination are arranged adjacent to one another so as to form the combination; counting the number of scatter symbols before and after re-scrolling; and awarding a prize according to the combination of the combination symbols after re-scrolling operation and the number of scatter symbols thus counted, and not awarding a prize according to the combination of the combination symbols before re-scrolling.

With such an arrangement, the scrolling is performed for all the scrolling lines. After a predetermined period of time, the scrolling is temporarily stopped for all the scrolling lines. When there is a combination symbol in the active pay area on one side of the display, the re-scrolling operation is performed for the scrolling lines on which the combination symbols are displayed on the other side thereof, and the re-scrolling operation of the scrolling lines is stopped such that the combination symbol on the one side of the display and the combination symbols on the other side thereof are arranged such that they form a combination in the active pay area. Accordingly, the present invention provides a function whereby, in a case where a predetermined condition has been satisfied, the re-scrolling operation is performed, which changes the symbols thus displayed. Such an arrangement provides the player with an enhanced sense of expectation. Furthermore, the re-scrolling operation according to the present invention can change the prize to be awarded to the player. This maintains the sense of tension for the player throughout the game, thereby increasing the amusement value of the game.

Moreover, a method of controlling a slot machine according to the present invention includes processes for: displaying a plurality of symbols on a display; scrolling the symbols displayed on the display in each scrolling line, stopping scrolling after a predetermined period of time; re-scrolling a scrolling line other than a first scrolling line on which a first symbol of a predetermined combination has been stopped; stopping re-scrolling such that the first symbol and a second symbol of the combination are arranged adjacent to one another so as to form the combination; counting the number of scatter symbols before and after re-scrolling; and awarding a prize according to the combination of the combination symbols before re-scrolling, the combination of the combination symbols after re-scrolling, and the number of scatter symbols thus counted.

With such an arrangement, the scrolling is performed for all the scrolling lines. After a predetermined period of time, the scrolling is temporarily stopped for all the scrolling lines. When there is a combination symbol in the active pay area on one side of the display, the re-scrolling operation is performed for the scrolling lines on which the combination symbols are displayed on the other side thereof, and the re-scrolling operation of the scrolling lines is stopped such that the combination symbol on the one side of the display and the combination symbols on the other side thereof are arranged such that they form a combination in the active pay area. Accordingly, the present invention provides a function whereby, in a case where a predetermined condition has been satisfied, the re-scrolling operation is performed, which changes the symbols thus displayed. Such an arrangement provides the player with an enhanced sense of expectation. Furthermore, with the present invention, the prize is obtained by calculating the sum of the prize determined before the re-scrolling operation and the prize determined after the re-scrolling operation. Such an arrangement enhances the player's sense of expectation with regard to the re-scrolling operation.

In addition, a method of controlling a slot machine according to the present invention includes processes for: displaying a plurality of symbols on a display; scrolling the symbols displayed on the display in each scrolling line; stopping scrolling after a predetermined period of time; re-scrolling a scrolling line other than a first scrolling line on which a first symbol of a predetermined combination has been stopped; stopping re-scrolling such that the first symbol and a second symbol of the combination are arranged adjacent to one another so as to form the combination; counting the number of scatter symbols before and after re-scrolling; and awarding a prize according to the combination of the combination symbols after re-scrolling and the number of scatter symbols thus counted, and not awarding a prize according to the combination of the combination symbols before re-scrolling. With such an arrangement, a predetermined active pay area and a predetermined non-active pay area are displayed on the display.

With such an arrangement, the scrolling is performed for all the scrolling lines. After a predetermined period of time, the scrolling is temporarily stopped for all the scrolling lines. When there is a combination symbol in the active pay area on one side of the display, the re-scrolling operation is performed for the scrolling lines on which the combination symbols are displayed on the other side thereof, and the re-scrolling operation of the scrolling lines is stopped such that the combination symbol on the one side of the display and the combination symbols on the other side thereof are arranged such that they form a combination in the active pay area. Accordingly, the present invention provides a function whereby, in a case where a predetermined condition has been satisfied, the re-scrolling operation is performed, which changes the symbols thus displayed. Such an arrangement provides the player with an enhanced sense of expectation. In addition, according to the present invention, the non-active pay area is displayed on the display. Such an arrangement allows the player to predict which of the symbols will transition from the non-active pay area to the active pay area in the re-scrolling operation, which is performed after all the scrolling lines are temporarily stopped, after the scrolling is performed for all the scrolling lines for a predetermined period of time. Such an arrangement provides an enhanced sense of expectation to the player. Furthermore, such an arrangement provides the re-scrolling function which can change the prize to be awarded to the player. This maintains the sense of tension for the player throughout the game, which increases the amusement value of the game.

Moreover, a method of controlling a slot machine according to the present invention includes processes for: displaying a plurality of symbols on a display; scrolling the symbols displayed on the display in each scrolling line, stopping scrolling after a predetermined period of time; re-scrolling a scrolling line other than a first scrolling line on which a first symbol of a predetermined combination has been stopped; stopping re-scrolling such that the first symbol and a second symbol of the combination are arranged adjacent to one another so as to form the combination; counting the number of scatter symbols before and after re-scrolling operation; and awarding a prize according to the combination of the combination symbols before re-scrolling, the combination of the combination symbols after re-scrolling, and the number of scatter symbols thus counted. With such an arrangement, a predetermined active pay area and a predetermined non-active pay area are displayed on the display.

With such an arrangement, the scrolling is performed for all the scrolling lines. After a predetermined period of time, the scrolling is temporarily stopped for all the scrolling lines. When there is a combination symbol in the active pay area on one side of the display, the re-scrolling operation is performed for the scrolling lines on which the combination symbols are displayed on the other side thereof, and the re-scrolling operation of the scrolling lines is stopped such that the combination symbol on the one side of the display and the combination symbols on the other side thereof are arranged such that they form a combination in the active pay area. Accordingly, the present invention provides a function whereby, in a case where a predetermined condition has been satisfied, the re-scrolling operation is performed, which changes the symbols thus displayed. Such an arrangement provides the player with an enhanced sense of expectation. In addition, according to the present invention, the non-active pay area is displayed on the display. Such an arrangement allows the player to predict which of the symbols will transition from the non-active pay area to the active pay area in the re-scrolling operation, which is performed after all of the scrolling lines are temporarily stopped, after the scrolling is performed for all of the scrolling lines for a predetermined period of time. Such an arrangement provides an enhanced sense of expectation to the player. Furthermore, with the present invention, the prize to be awarded is obtained by calculating the sum of the prize determined before the re-scrolling operation and the prize determined after the re-scrolling operation. Such an arrangement enhances the player's sense of expectation with regard to the re-scrolling operation.

Thus, the present invention provides a re-scrolling operation for the scrolling lines, which changes the symbols displayed on the active pay area. Such an arrangement provides an enhanced sense of expectation to the player.

### BRIEF DESCRIPTION OF THE DRAWINGS

FIG. 1 is a perspective view showing an external configuration of a slot machine according to an embodiment of the present invention;

FIG. 2 is an enlarged front view showing a display region of the slot machine at an enlarged scale;

FIG. 3 is a cross-sectional view taken along the line A-A in FIG. 2;

FIG. 4 is a perspective view showing a schematic configuration of a liquid crystal display device of the slot machine as viewed from the rear side;

FIG. 5 is a block diagram showing an electrical configuration of a control device included in the slot machine;

FIG. 6 is a block diagram showing an electrical configuration of a display/input control device included in the slot machine;

FIG. 7 is a flowchart illustrating the flow of the processing operation of the re-scrolling processing executed by the slot machine; and

FIG. 8 is a diagram illustrating the flow of the processing operation of the re-scrolling processing executed by the slot machine.

### DETAILED DESCRIPTION OF THE INVENTION

The present invention relates to a slot machine which provides functions of: scrolling symbols displayed on scrolling lines provided in a display unit; stopping temporarily scrolling after a predetermined period of time; determining whether or not a first symbol of a predetermined combination has been stopped; re-scrolling only the scrolling lines other than the scrolling line on which the first symbol has been stopped; and stopping re-scrolling such that the first symbol and a second symbols of the combination are arranged adjacent to one another, thereby forming the combination. A detailed description is provided below regarding embodiments of the present invention.

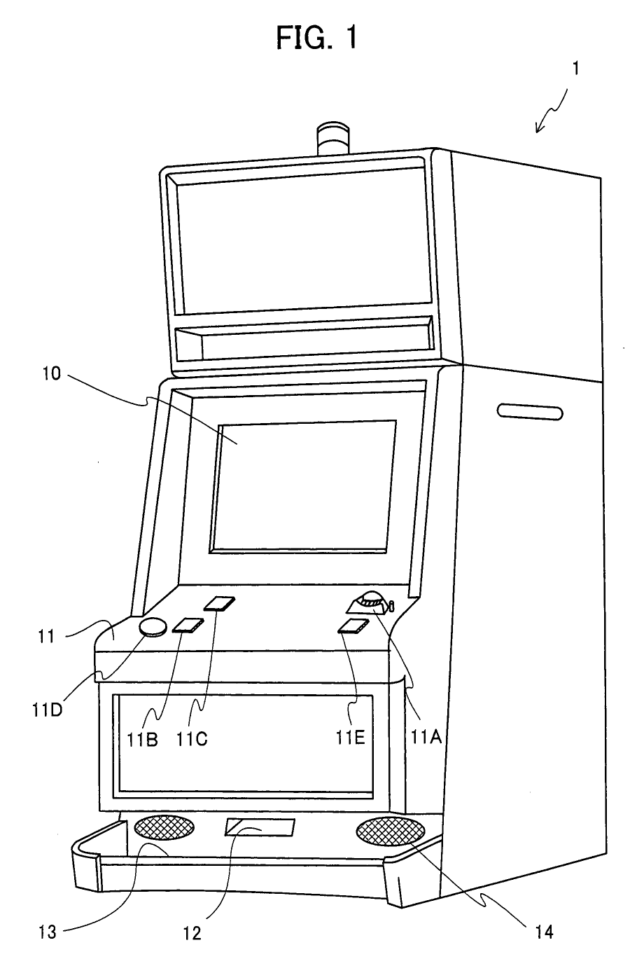

As shown in FIG. 1, a slot machine 1 according to an embodiment of the present invention includes a display unit (display) 10, an operation panel 11, a coin payout opening 12, a coin tray 13, and a sound output unit 14. It should be noted that slot machines can be classified into two general types. One is a slot machine having a configuration in which mechanical reels are rotated. The other is a so-called video slot machine having a configuration in which multiple virtual reels are rotated in the form of an image displayed on a screen. While a description is provided in the present embodiment regarding a slot machine employing mechanical reels, the present invention may be applied to a video slot machine.

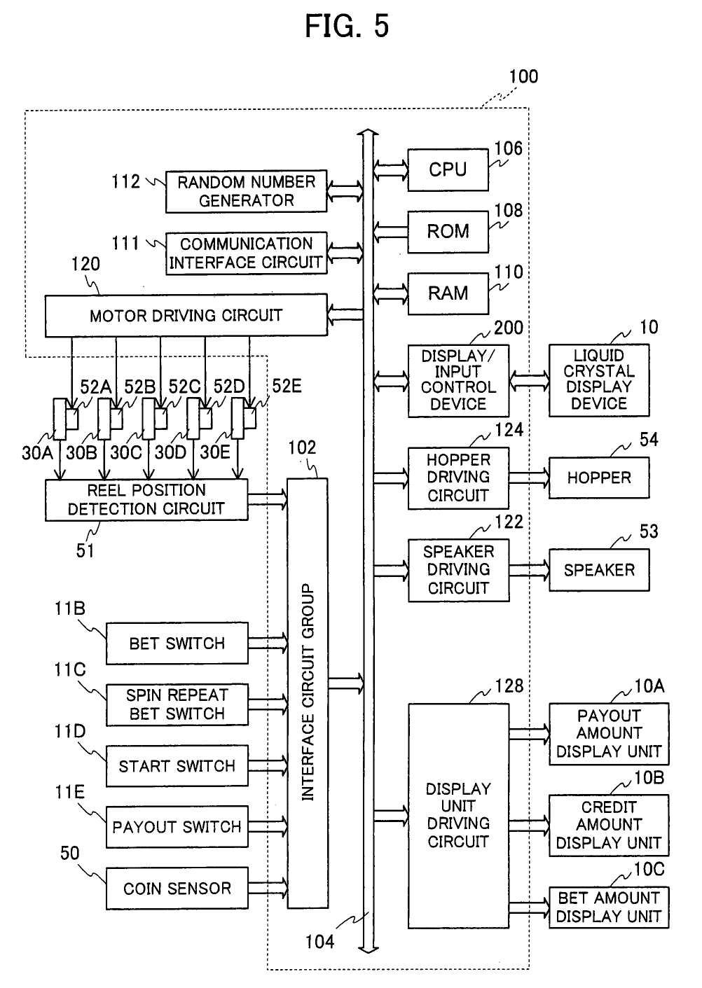

The slot machine 1 is installed at a predetermined location in an amusement facility such as a casino, etc. Furthermore, the slot machine 1 includes a control device 100 (see FIG. 5) mounted therewithin for electrically controlling each component. A description is provided later regarding the control device 100.

The display unit 10 is a component for displaying various kinds of images with respect to the game, examples of which include images which provide visual effects, and notification images. Such an arrangement allows the player to advance the game while visually recognizing the various kinds of images displayed on the display unit 10.

The display unit 10 includes a transparent liquid crystal panel 20. The transparent liquid crystal panel 20 has functions of: switching a part, or the entire area, of the liquid crystal panel 20 between a transparent state and an opaque state; and displaying various kinds of images. A detailed description is provided later regarding the configuration of the display unit 10.

Furthermore, the display unit 10 includes a reel group 3 on the rear side thereof. Here, multiple kinds of designs (symbols) are depicted on the outer face of each reel. The reel group 3 includes five mechanical reels 30A through 30E rotatably disposed along the horizontal direction. The mechanical reels 30A through 30E serve as multiple symbol display units. The mechanical reels 30A through 30E have a function of displaying multiple kinds of symbols, which are necessary for a basic game, including a bonus trigger symbol, both when displayed scrolling and displayed statically. With such an arrangement, when the transparent liquid crystal panel 20 is in the transparent state, such various kinds of symbols depicted on the mechanical reels 30A through 30E are visible to the player.

The operation panel 11 includes a coin insertion opening 11A which allows the player to insert coins into the slot machine 1. Furthermore, the operation panel 11 includes a BET switch 11B that allows the player to select the number of coins to be bet on the active pay area L. which is described later. Moreover, the operation panel 11 includes a spin repeat bet switch 11C that allows the player to play the game again without changing the number of coins to be bet on the active pay area L from that in the immediately previous game. The slot machine 1 allows the player to set the number of coins bet on the active pay area L according to the user's operation by performing a pushing operation on either the BET switch 11B or the spin repeat bet switch 11C.

Furthermore, the operation panel 11 includes a start switch ID, which is a game start instruction receiving means that allows the player to input the basic game start instruction in increments of games. Pushing either the spin repeat bet switch 11C or the start switch 11D serves as a trigger that instructs the slot machine 1 to start a game, upon which the five mechanical reels 30A and 30E begin to scroll.

Furthermore, the operation panel 11 includes a payout switch 11E. Upon the player performing a pushing operation on the payout switch 11E, the coins inserted by the player are paid out via the coin payout opening 12. The coins paid out are retained in the coin tray 13.

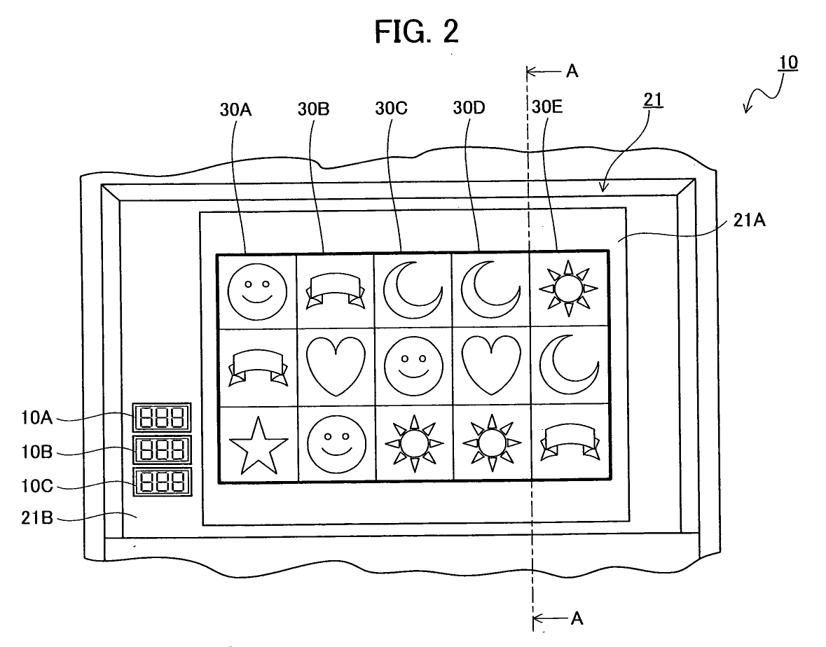

FIG. 2 is an enlarged view of the display unit 10. The display unit 10 includes a front panel 21. It should be noted that the transparent liquid crystal panel 20 is disposed on the back face of the front panel 21. The front panel 21 includes a transparent display screen 21A and a design formation area 21B upon which designs have been formed. Such an arrangement allows the player to visually recognize the image information displayed on the transparent liquid crystal panel 20 through the display screen 21A of the front panel 21. On the other hand, when the region of the aforementioned transparent liquid crystal panel 20 is in the transparent state, each of the symbols on the five mechanical reels 30A through 30E can be visually recognized through the display screen 21A.

Furthermore, the display unit 10 includes a payout amount display unit 10A, a credit amount display unit 10B, and a BET amount display unit 10C.

With such an arrangement, the display screen 21A has an active pay area L. After the rotation of all of the mechanical reels 30A through 30E has been stopped, a prize is determined based upon the symbol combination displayed statically in the active pay area L. Specifically, the active pay area L displays symbols arranged in the form of a 3×5 matrix, i.e., the upper symbol, the middle symbol, and the lower symbol, depicted on the mechanical reel 30A; the upper symbol, the middle symbol, and the lower symbol, depicted on the mechanical reel 30B; the upper symbol, the middle symbol, and the lower symbol, depicted on the mechanical reel 30C; the upper symbol, the middle symbol, and the lower symbol, depicted on the mechanical reel 30D; and the upper symbol, the middle symbol, and the lower symbol, depicted on the mechanical reel 30E. In addition, an arrangement may be made to display a non-active pay area M on the display screen 21A, in addition to the active pay area L. Such an arrangement allows the player to predict the symbols which will transition from the non-active pay area M to the active pay area L by way of re-scrolling. Thus, the present invention provides the player with an enhanced sense of expectation.

A payout amount display unit 10A is a component for displaying the amount of coins paid out when the player wins the game. The credit amount display unit 10B is a component for displaying the amount of credits stored in the slot machine 1. The BET amount display unit 10C is a component for displaying the bet amount, which is the number of coins bet on the aforementioned active pay area L. Each of the various kinds of display units 10A through 10C includes a 7-segement indicator. Alternatively, the various kinds of indicators 10A through 10C may be provided on the liquid crystal display 20 in the form of images.

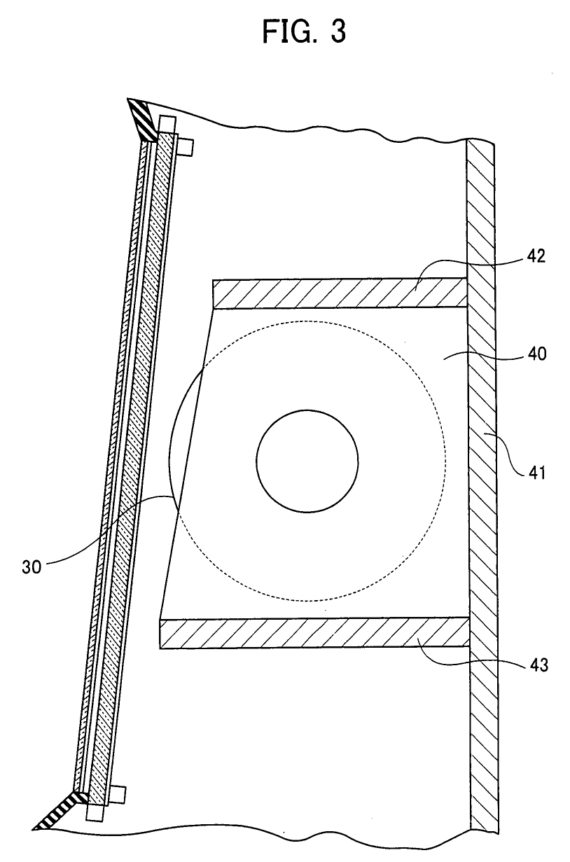

FIG. 3 is a cross-sectional view taken along the line A-A of FIG. 2. Each of the mechanical reels 30A through 30E is independently rotatably supported by the reel frame 40. It should be noted that a stepping motor, which is not shown, is disposed to the reel frame 40 for providing a function of rotating each of the mechanical reels 30A through 30E, and a function of stopping the rotation thereof. The reel frame 40 is disposed between an upper frame 42 and a lower frame 43 attached to a main frame 41.

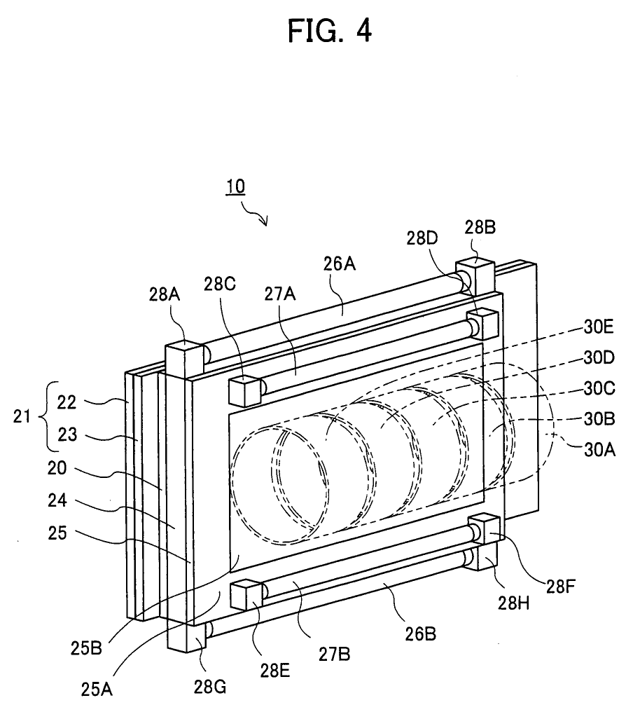

Next, a description is provided regarding a detailed configuration of the display unit 10. As shown in FIG. 4, the display unit 10 includes: the transparent liquid crystal panel 20; the front panel 21 having a touch panel 22 and a display plate 23; a light guide plate 24; a reflecting film 25; fluorescent lamps 26A, 26B, 27A, and 27B, each of which, is a so-called white light source; and lamp holders 28A, 28B, 28C, 28D, 28E, 28F, 28G, and 28H. Furthermore, the display unit includes a table carrier package (TCP) mounting liquid crystal panel driving ICs, which is not shown. The TCP is formed of a flexible substrate (not shown) connected to a terminal of the transparent liquid crystal panel 20. Furthermore, the touch panel 22 is formed of a transparent member. The display plate 23 is formed of a transparent member.

The display unit 10 is provided at a position forward of the display regions of the mechanical reels 30A through 30E (forward of the display screen 21A) such that it covers the mechanical reels 30A through 30E. Here, the mechanical reels 30A through 30E and the display unit 10 are disposed with a predetermined interval apart.

The transparent liquid crystal panel 20 has a structure in which a transparent substrate such as a glass substrate, upon which a thin film transistor layer is formed, and another transparent substrate are mounted so as to face each other with a certain gap therebetween, and the gap between the substrates is occupied by a liquid crystal. The display mode of the transparent liquid crystal panel 20 is set to be normally white. The term “normally white” as used here represents a mode in which the liquid crystal panel displays a white image (i.e., the light passing through the liquid crystal panel toward the display screen side is visible to the player) in the state in which the liquid crystal is not driven. As described above, with the present embodiment, the transparent liquid crystal panel 20 set to be in the normally white state is employed. Such an arrangement allows the player to visually recognize the symbols on the mechanical reels 30A through 30E when scrolling and when stopped, even if a situation arises in which the liquid crystal is inoperable, thereby allowing the player to continue the game even if such a situation has occurred. That is to say, even in a case where such an accident has occurred, the player can play the game switching between the scrolling and stopped symbols of the mechanical reels 30A through 30E.

The light introducing plate 24 introduces the light emitted from the fluorescent lamps 26A and 26B to the transparent liquid crystal panel 20 (in other words, the transparent liquid crystal panel 20 is illuminated). The light guide plate 24 is provided on the rear face side of the transparent liquid crystal panel 20, and is formed of a transparent member (having a light guiding function) such as acrylic resin or the like, with a thickness of around 2 cm, for example.

The reflecting film 25 thus employed has a structure in which an evaporated silver film is formed on a white polyester film or an aluminum thin film, for example. The reflecting film 25 reflects the light introduced via the light guide plate 24 toward the front side of the light guide plate 24. The reflecting film 25 includes a reflecting region 25A and a non-reflecting region (transmissible region) 25B, as shown in FIG. 4. Here, the non-reflecting region 25B is formed of a transparent member, and is disposed in the region of the front panel 21 that covers the front face of the mechanical reels 30A through 30E.

The fluorescent lamps 26A and 26B are disposed along the upper end and the lower end of the light guide plate 24, respectively, with the ends of the fluorescent lamps held by the lamp holders 28A, 28B, 28G, and 28H. The light emitted from the fluorescent lamps 26A and 26B is reflected by the reflecting region 25A of the reflecting film 25, thereby illuminating the transparent liquid crystal panel 20. On the other hand, the fluorescent lamps 27A and 27B are disposed at an upper position and a lower position on the rear side of the reflecting film 25, respectively, such that they face the mechanical reels 30A through 30E, with the ends of the fluorescent lamps held by the lamp holders 28C, 28D, 28E, and 28F. The light emitted from the fluorescent lamps 27A and 27B is reflected by the surfaces of the mechanical reels 30A through 30E, and is input to the non-reflecting region 25B, thereby illuminating the transparent liquid crystal panel 20. As described above, with regard to the display unit 10, the transparent liquid crystal panel 20 is illuminated by the light which is emitted from the fluorescent lamps 26A and 26B and which is reflected by the reflecting region 25A of the reflecting film 25, and by the light which is emitted from the fluorescent lamps 27A and 27B, which is reflected by the surfaces of the mechanical reels 30A through 30E, and which is input to the non-reflecting region 25B. Accordingly, the region of the display unit 10 that corresponds to the non-reflecting region 25B of the reflecting film 25 has a function of switching between a transparent state and an opaque state according to whether or not the liquid crystal is being operated. On the other hand, the region of the liquid crystal display device that corresponds to the reflecting region 25A of the reflecting film 25 remains in the opaque state regardless of whether or not the liquid crystal is being operated.

A description is provided regarding the slot machine 1 in which a part of the display screen of the display unit 10 has a function of switching between a transparent state and an opaque state. Also, an arrangement may be made in which the entire area of the display screen of the display unit 10 has a function of switching between a transparent state and an opaque state. With such an arrangement in which the entire area of the display screen of the display unit 10 has a function of switching between a transparent state and an opaque state, the reflecting film 25 is formed of the non-reflecting region 25B alone. Alternatively, the reflecting film 25 may be eliminated.

Next, a description is provided regarding a configuration of the control device 100. As shown in FIG. 5, the control device 100 is a microcomputer, and includes an interface circuit group 102, an input/output bus 104, a CPU 106, ROM 108, RAM 110, a communication interface circuit 111, a random number generator 112, a motor driving circuit 120, a speaker diving circuit 122, a hopper driving circuit 124, a display unit driving circuit 128, and a display/input control device 200.

The interface circuit group 102 is connected to the input/output bus 104. Furthermore, the input/output bus 104 inputs/outputs data signals or address signals to/from the CPU 106.

The start switch 11D is connected to the interface circuit group 102. The start signal output from the start switch 11D is converted into a predetermined signal by the interface circuit group 102, and the start signal thus converted is supplied to the input/output bus 104.

Furthermore, the BET switch 11B, the spin repeat bet switch 11C, and the payout switch 11E are connected to the interface circuit group 102. Each of the switching signals output from the switches 11B, 11C, and 11E is also supplied to the interface circuit group 102, and is converted into a predetermined signal by the interface circuit group 102. The switching signals thus converted are supplied to the input/output bus 104.

Furthermore, a coin sensor 50 is connected to the interface circuit group 102. The coin sensor 50 is a sensor for detecting the coins inserted into the coin insertion opening 11A. The coin sensor 50 is provided in combination with the coin insertion opening 11A. The sensing signal output from the coin sensor 50 is also supplied to the interface circuit group 102, and is converted into a predetermined signal by the interface circuit group 102. The sensing signal thus converted is supplied to the input/output bus 104.

Furthermore, a reel position detecting circuit 51 is connected to the interface circuit group 102. The reel position detecting circuit 51 is a circuit for detecting the rotational position for each of the mechanical reels 30A through 30E based on the pulse signals received from a reel rotational position sensor (not shown). The detection signal output from the reel position detecting circuit 51 is also supplied to the interface circuit group 102, and is converted into a predetermined signal by the interface circuit group 102. The detection signal thus converted is supplied to the input/output bus 104.

Furthermore, the ROM 108 and the RAM 110 are connected to the input/output bus 104.

The CPU 106 reads out a first gaming program, programmed so as to provide a function of: beginning the variable display of symbols for all the lines, the symbol transition display mode is started for all the lines, i.e., the mechanical reels 30A through 30E, upon reception of a basic game start instruction operation via the start switch 11D, followed by stopping the variable display of symbols for all the lines, i.e., the mechanical reels 30A through 30E; and awarding units of a gaming medium according to the prize-winning symbol combination, in a case where the symbol combination in the stationary state indicates that the player has won a prize. Thus, the CPU 106 executes the basic game.

Furthermore, the CPU 106 reads out a second gaming program, and executes a free game, for example, in a case where a bonus trigger symbol or a bonus trigger symbol combination has occurred when all the symbols are statically displayed. Here, each symbol belongs to a corresponding line, i.e., corresponding to among the mechanical reels 30A through 30E.

The ROM 108 stores: a control program for central control of the slot machine 1; initial data for executing the control program; and various data tables used in the lottery processing.

The RAM 110 temporarily stores flags, variables, etc., used for the aforementioned control program.

Furthermore, a communication interface circuit 111 is connected to the input/output bus 104. The communication interface circuit 111 is a circuit for communicating with a server, etc., via various kinds of communication networks including a public telephone line network, LAN, etc.

Furthermore, the random number generator 112 for generating a random number is connected to the input/output bus 104. The random number generator 112 generates a random number in a predetermined range, e.g., in a range of 0 and 65535. Alternatively, an arrangement may be made in which the CPU 106 generates a random number by computation.

A motor driving circuit 120 for driving the stepping motors 52A through 52E and a display unit driving circuit 128 for driving each of the various kinds of display units 10A through 10C are connected to the input/output bus 104. The CPU 106 controls the operations of the various kinds of display units 10A through 10C and the stepping motors 52A through 52E via the motor driving circuit 120 and the display unit driving circuit 128 according to the occurrence of predetermined events.

Furthermore, the speaker driving circuit 122 for driving the speaker 53 is connected to the input/output bus 104. The CPU 106 reads out the sound data stored in the ROM 108, and transmits the sound data thus read out to the speaker driving circuit 122 via the input/output bus 104, thereby providing predetermined sound effects generated by the speaker 53.

Moreover, the hopper driving circuit 124 for driving the hopper 54 is connected to the input/output bus 104. Upon reception of a cash-out signal input from the payout switch 11E, the CPU 106 transmits a driving signal to the hopper driving circuit 124 via the input/output bus 104. The hopper 54 then proceeds to pay out an amount of coins that corresponds to the credit remaining at the current point in time, as stored in a predetermined memory area of the RAM 110.

In addition, the display/input control device 200 is connected to the input/output bus 104. The CPU 106 creates an image display command corresponding to the state and results of the game, and outputs the image display command thus created to the display/input control device 200 via the input/output bus 104. Upon reception of the image display command input from the CPU 106, the display/input control device 200 creates a driving signal for driving the display unit 10 according to the image display command thus input, and outputs the driving signal thus created to the display unit 10, thereby displaying a predetermined image on the transparent liquid crystal panel 20 of the display unit 10. The display/input control device 200 transmits the signal input via the touch panel 22 formed on the display unit 10 to the CPU 106 via the input/output bus 104 as an input signal.

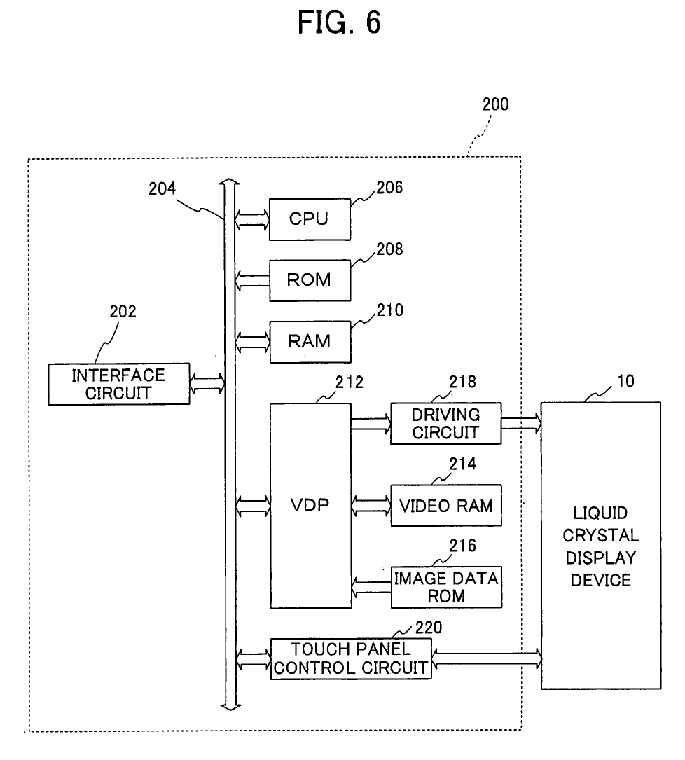

A description is provided below regarding the configuration of the display/input control device 200. The display/input control device 200 is a sub-microcomputer which performs image display processing and controls the input operation via the touch panel 22. As shown in FIG. 6, the display/input control device 200 includes an interface circuit 202, an input/output bus 204, a CPU 206, ROM 208, RAM 210, a VDP 212, video RAM 214, image data ROM 216, a driving circuit 218, and a touch panel control circuit 220.

The interface circuit 202 is connected to the input/output bus 204. The image display command output from the CPU 106 of the control device 100 is supplied to the input/output bus 204 via the interface circuit 202. The input/output bus 204 performs input/output of data signals or address signals to/from the CPU 206.

Furthermore, the ROM 208 and the RAM 210 are connected to the input/output bus 204. The ROM 208 stores a display control program for generating a driving signal, which is to be supplied to the display unit 10, according to an image display command received from the CPU 106 of the aforementioned control device 100. On the other hand, the RAM 210 stores flags and variables used in the aforementioned display control program.

Moreover, the VDP 212 is connected to the input/output bus 204. The VDP 212 includes a so-called sprite circuit, a screen circuit, a palette circuit, etc., and can perform various kinds of processing for displaying images on the display unit 10. With such an arrangement, the components connected to the VDP 212 include: the video RAM 214 for storing image data according to the image display command received from the CPU 106 of the aforementioned control device 100; and the image data ROM 216 for storing various kinds of image data, including the aforementioned image data for visual effects, etc. In addition, the driving circuit 218 for outputting a driving signal for driving the display unit 10 is connected to the VDP 212.

The CPU 206 reads out the display control program stored in the ROM 208 and executes the display control program thus read out, which instructs the video RAM 214 to store the image data which is to be displayed on the display unit 10 according to the image display command received from the CPU 106 of the aforementioned control device 100.

The image data ROM 216 stores various kinds of image data, including the image data that provides visual effects.

The touch panel control circuit 220 transmits the signal input via the touch panel 22 formed on the display unit 10 to the CPU 106 as an input signal via the input/output bus 204.

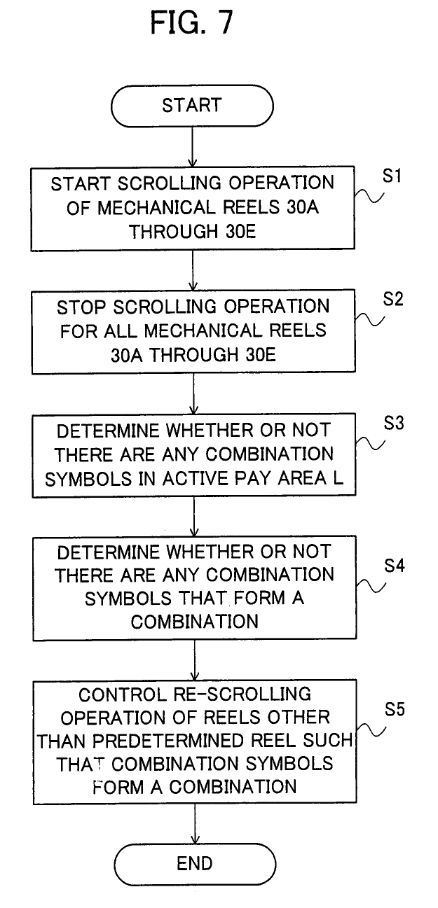

Next, a description is given regarding the process flow of the game provided by the above-described slot machine 1 with reference to FIG. 7.

In step S1, upon the player performing a pushing operation on either the spin repeat bet switch 11C or the start switch 11D, the CPU 106 performs a control operation such that all the mechanical reels 30A through 30E begin scrolling.

In step S2, after a predetermined period of time elapses, the CPU 106 stops all of the mechanical reels 30A through 30E.

In step S3, the CPU 106 determines whether or not there is a combination symbol depicted on a predetermined reel (e.g., mechanical reel 30A) that is stopped in the active pay area L. Furthermore, in this step, the CPU 106 counts the number of scatter symbols displayed statically in the active pay area L. The CPU 106 stores the number of scatter symbols in the RAM 110.

Moreover, in this step, the CPU 106 determines whether or not the player has won a prize according to a combination of combination symbols arranged in the active pay area L. In a case where the player has won a prize, the CPU 106 instructs the RAM 110 to store the information to the effect that the player has won the prize.

A description is provided below regarding the symbols. The kinds of symbols employed in the present embodiment include a “face” symbol, a “ribbon” symbol, a “heart” symbol, a “moon” symbol, a “sun” symbol, a “star” symbol, etc. With such an arrangement, in a case where a predetermined symbol combination (combination) is arranged in the active pay area L, the player wins a prize. With the present embodiment, when a predetermined combination of special symbols is thus arranged, the player wins a prize. Such a special symbol is referred to as a “combination symbol”.

For example, the ROM 108 stores a data table with information to the effect that the “face” symbol is set to be a combination symbol, and to the effect that, in a case where the “face” symbols are arranged consecutively such that they form a horizontal line in the active pay area, the player wins a prize. Furthermore, the data table stores the information to the effect that the “ribbon” symbol is set to be another combination symbol, and to the effect that, in a case where the “ribbon” symbols are arranged consecutively such that they form a horizontal line in the active pay area, the player wins a prize. In addition, the ROM 108 stores a data table that determines the number of coins to be paid out according to a prize won by the player.

With regard to the combination symbols, different symbols can form a combination of combination symbols, such as a combination of combination symbols formed of the “heart” symbols and the “sun” symbols, in addition to a combination of combination symbols formed of the same symbols. Moreover, the “star” symbol serves as a scatter symbol. With such an arrangement, when there is any scatter symbol displayed statically in the active pay area L, the player wins a prize.

In a case where the CPU 106 has determined that a combination symbol has stopped in the active pay area L of a predetermined reel, the flow proceeds to step S4.

In step S4, in a case where determination has been made in step S3 that a combination symbol has stopped, the CPU 106 determines whether or not there is a combination symbol (e.g., “face” symbol) that forms a combination with the aforementioned combination symbol (e.g., “face” symbol) for each of the other reels.

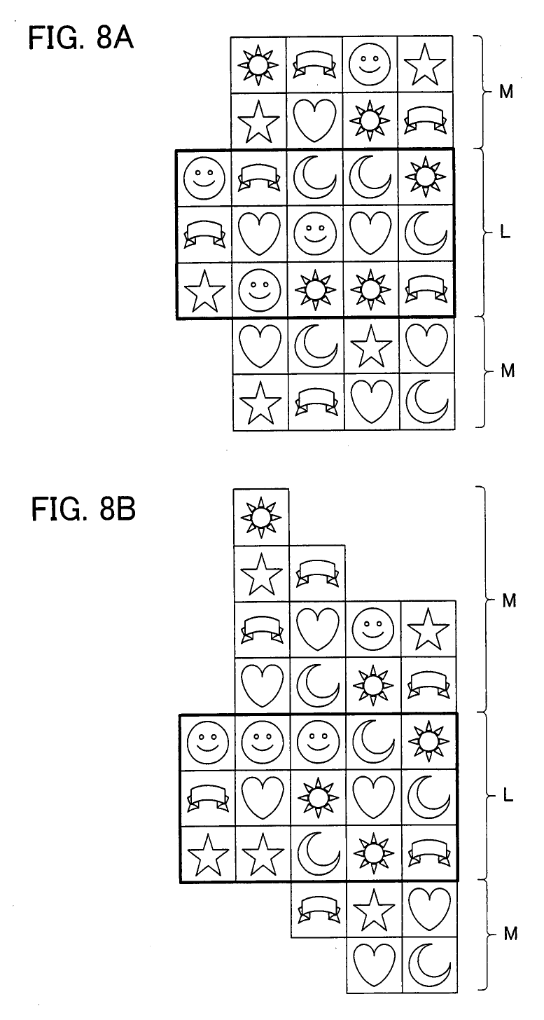

In a case in which, in Step S2, the rotation of the mechanical reels 30A through 30E has been stopped, and the symbols are displayed statically as shown in FIG. 8(A), the CPU 106 determines that the “face” symbol depicted on the mechanical reel 30A is displayed statically in the active pay area L. Next, the CPU 106 determines whether or not there is a “face” symbol displayed in the active pay area L for each of the other mechanical reels, i.e., the mechanical reels 30B through 30E. In this case, the CPU 106 determines that there are “face” symbols displayed statically for each of the mechanical reels 30B and 30C.

In a case where the CPU 106 has determined that there is a combination symbol displayed in the active pay area with respect to a predetermined reel in the stationary state, the flow proceeds to step S5.

In step S5, the CPU 106 performs a control operation such that a combination of combination symbols is formed after the re-scrolling operation of the reels other than the predetermined reel.

For example, the CPU 106 controls the motor driving circuit 120 such that three consecutive “face” symbols are arranged along a horizontal line in the active pay area L, as shown in FIG. 8(B). Specifically, the CPU 106 controls the motor driving circuit 120 so as to re-scroll in order to move the mechanical reel 30B upward by two frames and to move the mechanical reel 30C upward by one frame.

In this case, the re-scrolling operation, in which the mechanical reel 30B is moved upward by two frames, leads to an additional scatter symbol moving from the non-active pay area M to the active pay area L. Accordingly, the CPU 106 increments the number of scatter symbols by 1.

In addition, an arrangement may be made in which the player does not win a prize before the re-scrolling operation. With such an arrangement, the player wins a prize according to the combination of the combination symbols and the number of scatter symbols that are counted after the re-scrolling operation. In the above case, a scatter symbol displayed in the active pay area before the re-scrolling operation moves to the non-active pay area. Accordingly, the CPU 106 awards a prize according to the three “face” symbols and the one scatter symbol.

Furthermore, an arrangement may be made in which the player wins a prize according to the symbol combination and the number of scatter symbols that are counted before and after the re-scrolling operation. With such an arrangement, in the aforementioned case, the CPU 106 awards a prize according to the three “face” symbols and two scatter symbols.

As described above, the slot machine 1 according to the present embodiment includes the display unit 10 that displays multiple symbols, and a CPU 106 which provides functions of: scrolling the symbols displayed in the display unit 10 in increments of scrolling lines (mechanical reels 30A through 30E); stopping the rotation of the mechanical reels 30A through 30E after a predetermined period of time has elapsed; re-scrolling the scrolling lines (e.g., the mechanical reels 30B through 30E), other than the first scrolling line (e.g., the mechanical reel 30A) on which the combination symbol is displayed statically on one side of the display unit 10, in a case where determination has been made that there is a combination symbol displayed statically on one side of the display unit 10, which has been defined as a special symbol that can form a combination with another combination symbol; and stopping the re-scrolling operation of the scrolling lines (mechanical reels 30B through 30E) such that the combination symbol displayed on the one side of the display unit 10 and the combination symbols displayed on the other side thereof are arranged adjacent to one another in the form of a combination of combination symbols. With such an arrangement, in a case where a predetermined condition has been satisfied, the re-scrolling operation is performed, which changes the symbols that were temporarily displayed statically. Such an arrangement offers the player an enhanced sense of expectation.

Furthermore, the slot machine 1 according to the present invention has a configuration in which the non-active pay area is displayed on the display unit 10 in addition to the active pay area L. With such an arrangement, the player can predict which symbol will transition from the non-active pay area M to the active pay area L. Such an arrangement offers the player an enhanced sense of expectation. For example, the player can predict that a symbol, which is temporarily displayed statically in the non-active pay area M, will transition to the active pay area L after the re-scrolling operation, enhancing the player's sense of expectation.

Moreover, with the slot machine 1 according to the present invention, the number of scatter symbols may be counted before and after the re-scrolling operation. In a case where the re-scrolling operation is performed, the slot machine 1 may not award a prize according to the combination of the combination symbol on the one side of the display unit 10 and the combination symbols on the other side thereof formed before the re-scrolling operation. In this case, the slot machine 1 may award a prize according to the combination of the combination symbol on the one side of the display unit 10 and the combination symbols on the other side thereof, and the number of scatter symbols that are counted after the re-scrolling operation. With such an arrangement, in some cases, the prize to be awarded changes. Thus, such an arrangement provides a game with a sense of tension, thereby providing more amusement.

In addition, with the slot machine 1 according to the present invention, the number of scatter symbols may be counted before and after the re-scrolling operation. In a case where the re-scrolling operation is performed for the mechanical reels, the slot machine 1 may award a prize according to the combination of the combination symbol on the one side of the display unit 10 and the combination symbols on the other side thereof formed before the re-scrolling operation, the combination of the combination symbol on the one side of the display unit 10 and the combination symbols on the other side thereof formed after the re-scrolling operation, and the number of scatter symbols thus counted before and after the re-scrolling operation. With such an arrangement, the prize to be awarded to the player is calculated by adding the prizes determined before and after the re-scroll operation. With such an arrangement, the re-scrolling operation increases the player's sense of expectation.

It should be noted that the present invention is not restricted to the above-described embodiments. Rather, it is needless to say that various modifications and changes can be made without departing from the technical scope of the present invention.

What is claimed is:

1. A slot machine comprising:
a display which displays a plurality of symbols; and
a game controller which provides functions of:
scrolling the symbols displayed on the display in each scrolling line;
stopping scrolling after a predetermined period of time;
re-scrolling a scrolling line other than a first scrolling line on which a first symbol of a predetermined combination has been stopped; and
stopping re-scrolling such that the first symbol and a second symbol of the combination are arranged adjacent to one another so as to form the combination.

2. A slot machine according to claim 1, wherein
the display displays a predetermined active pay area and a predetermined non-active pay area.

3. A slot machine according to claim 1, wherein
the game controller counts the number of scatter symbols before and after re-scrolling; and
the game controller does not award a prize according to the combination before re-scrolling, and awards a prize according to the combination after re-scrolling and the number of scatter symbols thus counted.

4. A slot machine according to claim 1, wherein
the game controller counts the number of scatter symbols before and after re-scrolling; and
the game controller awards a prize according to the combination before re-scrolling, the combination after re-scrolling, and the number of scatter symbols thus counted.

5. A slot machine comprising:
a display which displays a plurality of symbols; and
a game controller which provides functions of:
scrolling the symbols displayed on the display in each scrolling line;
stopping scrolling after a predetermined period of time;
re-scrolling a scrolling line other than a first scrolling line on which a first symbol of a predetermined combination has been stopped; and
stopping re-scrolling such that the first symbol and the a second symbol of the combination are arranged adjacent to one another so as to form the combination, wherein
the display displays a predetermined active pay area and a predetermined non-active pay area.

6. A slot machine comprising:
a display which displays a plurality of symbols; and
a game controller which provides functions of:
scrolling the symbols displayed on the display in each scrolling line;
stopping scrolling after a predetermined period of time;
re-scrolling a scrolling line other than a first scrolling line on which a first symbol of a predetermined combination has been stopped; and
stopping re-scrolling such that the first symbol and a second symbol of the combination are arranged adjacent to one another so as to form the combination; wherein
the game controller counts the number of scatter symbols before and after re-scrolling, and
the game controller does not award a prize according to the combination before re-scrolling, and award a prize according to the combination after re-scrolling and the number of scatter symbols thus counted.

7. A slot machine comprising:
a display which displays a plurality of symbols; and
a game controller which provides functions of:
scrolling the symbols displayed on the display in each scrolling line;
stopping scrolling after a predetermined period of time;
re-scrolling a scrolling line other than a first scrolling line on which a first symbol of a predetermined combination has been stopped; and
stopping re-scrolling such that the first symbol and a second symbol of the combination are arranged adjacent to one another so as to form the combination; wherein
the game controller counts the number of scatter symbols before and after re-scrolling, and
the game controller awards a prize according to the combination before re-scrolling, the combination after re-scrolling, and the number of scatter symbols thus counted.

8. A slot machine comprising:
a display which displays a plurality of symbols; and
a game controller which provides functions of:
scrolling the symbols displayed on the display in each scrolling line;
stopping scrolling after a predetermined period of time;
re-scrolling a scrolling lines other than a first scrolling line on which a first symbol of a predetermined combination has been stopped; and
stopping re-scrolling such that the first symbol and a second symbol of the combination are arranged adjacent to one another so as to form the combination; wherein
the display displays a predetermined active pay area and a predetermined non-active pay area,
the game controller counts the number of scatter symbols before and after re-scrolling, and
the game controller does not award a prize according to the combination before re-scrolling, and awards a prize according to the combination after re-scrolling and the number of scatter symbols thus counted.

9. A slot machine comprising:
a display which displays a plurality of symbols; and
a game controller which provides functions of:
scrolling the symbols displayed on the display in each scrolling line;
stopping scrolling after a predetermined period of time;
re-scrolling a scrolling lines other than a first scrolling line on which a first symbol of a predetermined combination has been stopped; and
stopping re-scrolling such that the first symbol and a second symbol of the combination are arranged adjacent to one another so as to form the combination; wherein
the display displays a predetermined active pay area and a predetermined non-active pay area,
the game controller counts the number of scatter symbols before and after re-scrolling, and
the game controller awards a prize according to the combination before re-scrolling, the combination after re-scrolling, and the number of scatter symbols thus counted.

10. A method of controlling a slot machine, comprising:
displaying a plurality of symbols on a display;
scrolling the symbols displayed on the display in each scrolling line,
stopping scrolling after a predetermined period of time;
re-scrolling a scrolling line other than a first scrolling line on which a first symbol of a predetermined combination has been stopped; and
stopping re-scrolling such that the first symbol and a second symbol of the combination are arranged adjacent to one another so as to form the combination.

11. A method according to claim 10, further comprising::
displaying a predetermined active pay area and a predetermined non-active pay area on the display.

12. A method according to claim 10, further comprising:
counting the number of scatter symbols before and after re-scrolling; and
awarding a prize according to the combination after re-scrolling and the number of scatter symbols thus counted, and not awarding according to the combination before re-scrolling.

13. A method according to claim 10, further comprising:
counting the number of scatter symbols before and after re-scrolling; and
awarding a prize according to the combination before re-scrolling, the combination after re-scrolling, and the number of scatter symbols thus counted.

14. A method of controlling a slot machine, comprising:
displaying a plurality of symbols on a display;
scrolling the symbols displayed on the display in each scrolling line;
stopping scrolling after a predetermined period of time;
re-scrolling a scrolling line other than a first scrolling line on which a first symbol of a predetermined combination has been stopped;
stopping re-scrolling such that the first symbol and a second symbol of the combination are arranged adjacent to one another so as to form the combination; and
displaying a predetermined active pay area and a predetermined non-active pay area on the display.

15. A method of controlling a slot machine, comprising:
displaying a plurality of symbols on a display;
scrolling the symbols displayed on the display in each scrolling line;
stopping scrolling after a predetermined period of time;
re-scrolling a scrolling lines other than a first scrolling line on which a first symbol of a predetermined combination has been stopped;
stopping re-scrolling such that the first symbol and a second symbol of the combination are arranged adjacent to one another so as to form the combination;
counting the number of scatter symbols before and after re-scrolling; and
awarding a prize according to the combination after re-scrolling and the number of scatter symbols thus counted, and not awarding a prize according to the combination before re-scrolling.

16. A method of controlling a slot machine, comprising:
displaying a plurality of symbols on a display;
scrolling the symbols displayed on the display in each scrolling line;
stopping scrolling after a predetermined period of time;
re-scrolling a scrolling lines other than a first scrolling line on which a first symbol of a predetermined combination has been stopped;
stopping re-scrolling such that the first symbol and a second symbol of the combination are arranged adjacent to one another so as to form the combination;
counting the number of scatter symbols before and after re-scrolling; and
awarding a prize according to the combination before re-scrolling, the combination after re-scrolling, and the number of scatter symbols thus counted.

17. A method of controlling a slot machine, comprising:
displaying a plurality of symbols on a display;
scrolling the symbols displayed on the display in each scrolling line;
stopping scrolling after a predetermined period of time;
re-scrolling a scrolling lines other than a first scrolling line on which a first symbol of a predetermined combination has been stopped;
stopping re-scrolling such that the first symbol and a second symbol of the combination are arranged adjacent to one another so as to form the combination;
counting the number of scatter symbols before and after re-scrolling;
awarding a prize according to the combination after re-scrolling and the number of scatter symbols thus counted, and not awarding a prize according to the combination before re-scrolling; and
displaying a predetermined active pay area and a predetermined non-active pay area on the display.

18. A method of controlling a slot machine, comprising:
displaying a plurality of symbols on a display;
scrolling the symbols displayed on the display in each scrolling line;
stopping scrolling after a predetermined period of time;
re-scrolling a scrolling lines other than a first scrolling line on which a first symbol of a predetermined combination has been stopped;
stopping re-scrolling such that the first symbol and a second symbol of the combination are arranged adjacent to one another so as to form the combination;
counting the number of scatter symbols before and after re-scrolling;
awarding a prize according to the combination before re-scrolling, the combination after re-scrolling, and the number of scatter symbols thus counted; and
displaying a predetermined active pay area and a predetermined non-active pay area.
